(19) United States
(12) Patent Application Publication
(10) Pub. No.: US 2021/0276295 A1
(43) Pub. Date: Sep. 9, 2021

(54) COLD COMPRESSION MOULD PROCESS AND APPARATUS

(71) Applicant: Andrew BRULE, West Vancouver (CA)

(72) Inventor: Andrew BRULE, West Vancouver (CA)

(21) Appl. No.: 16/350,610

(22) PCT Filed: Dec. 20, 2016
(86) PCT No.: PCT/CA2016/051515

§ 371 Date: Dec. 7, 2018

Related U.S. Application Data
(60) Provisional application No. 62/349,800, filed on Jun. 14, 2016.

(51) Int. Cl. B30B 15/02; B29C 43/36; A01J 25/13; A01J 25/15; C11D 13/18; C11D 13/16

(52) U.S. Cl. CPC B30B 15/02; B29C 43/361; A01J 25/13; B29C 2043/3628; C11D 13/18; C11D 13/16; A01J 25/15

(57) ABSTRACT

The process immerses a plurality of smaller solids in a liquid softening/solvent/bonding agent (i.e. water, oils, solvent or some other combination). This reagent reacts with the solids over a period of time so that when the cavity containing the solid/liquid mixture is compressed, the solids and any other additives (i.e. oatmeal, spices, other foreign objects, etc . . . ) are forced together and force the liquid softening/solvent/bonding agent out. The expelled liquids are removed from the solids and additives which are then allowed to dry/bond/fuse thereby forming a solid bond. Whereas there is prior art utilizing aspects of this process specifically in soap scrap bonding, this method is the only method of compressing solids that does not require electricity and where the disparate solid pieces and the bonding agent/liquid are all contained in one vessel that enable the solids to react with the liquids and then be compressed removing the bonding agent/liquid and leaving only the solids which can then form a permanent bond, all in one device (see FIG. 8: Novel Mould Assembly , FIG. 10—Mould Assembly Option, FIG. 12—Novel Mould Assembly with Option Plunger Design). Furthermore, this design can incorporate the collection and if desired recycling of the reagent within the mould itself (i.e. a hollow cavity in the plunger and if necessary a collection vessel attached to the cap and/or stabilizing base). Finally, the plunger design allows the device to be used with or without any mechanical aids to prevent it from binding during longitudinal movement during compression of the mould/plunger. This, first of all, simplifies the mechanics of the device and allows the mould to be used by young and old alike regardless of ability.

This device will have applications in many industries but especially the craft industry (i.e. cheese making and soap making).

### PRIOR ART

Other soap compression moulds involve pre-soaking the solids in a separate vessel then transferring the pre-softened solids to a mould of various designs for compression into a specific shape and bonding (see Publication Number CN204455059 U, Application number CN 201420797007 and U.S. Pat. No. 4,035,122 and Publication number U.S. Pat. No. 5,030,405 A). This method complicates the process which discourages mass adoption of the technology and process.

Another existing method which is used in bonding smaller disparate soap pieces in the same vessel as the “softening” process uses a heating element to vaporize water, the steam then softens the soap pieces and a flat plunger/stamp compresses the softened pieces together (see Publication number CN201873662 U, Application number CN 201020591642). The proposed process and apparatus addresses three important aspects not addressed by Publication number CN201873662 U, Application number CN 201020591642. First, Publication number CN201873662 U, Application number CN 201020591642 requires electricity to vaporize the water which limits its location of use to where there is electricity available and unnecessarily complicates the process which discourages mass adoption of the process. Second, Publication number CN201873662 U, Application number CN 201020591642 can only use water to soften the soap pieces so they can be bonded together under pressure (i.e. no essential oils or scents can be used). Third, the steam created in Publication number CN201873662 U, Application number CN 201020591642 is created under the soap pieces so it must have holes in the bottom of the mould cavity so the steam can surround the soap pieces. Therefore when the soap pieces are compressed to form a bond, the softened soap can protrude through the access holes for the steam which when solidified makes it difficult to remove and limits the embossed shapes to only one side of the newly formed solid (i.e. soap). The proposed Cold Mould Process and Apparatus addresses all these issues.

Device

This device simplifies the entire process for bonding a plurality of disparate solids into a single moulded solid by using a fluid tight mould cavity to immerse the solids in the bonding/softening/solvent fluid for a period of time and then using the plunger to both force the bonding/softening/solvent agent out from between the solids and compress the solids into a single mass to bond together. Further, the plunger has been designed to collect the exudates for reuse, disposal or recycling reducing the clean-up time. Although this may not be necessary for the application of the cold mould process, this apparatus design feature eliminates an inhibiting factor in the mass adoption of the device. The plunger is also designed to obviate the need for mechanical alignment/stabilization of the plunger while moving under force axially/longitudinally during the compression phase within the mould. Although this simplifies the device and encourages mass adoption it does not preclude the use of a mechanical compression method. Further, a stabilizing platform is designed to collect any exudates that might escape the plunger/mould device and will encourage users of all ages and abilities to use the device. Finally, please be advised that this process and apparatus could be used to bond/shape a plurality of disparate solids of a variety of composition, as long as the surface of the disparate solids can be made “bondable” (i.e. plastic pieces immersed in the appropriate solvent, soap immersed in water mixture, etc . . . ).

Design

Overview

The mould consists of a cap (bottom and/or top), a shaped enclosure (which may or may not be extruded, typical cross-sectional shapes would be round or some other polygon but in reality any cross-sectional shape or size is possible) that is secured to the cap by pressure and/or other mechanical means forming a liquid tight seal that may or may not include a flexible sealing gasket, and a form fitting plunger that fits the inside of the shaped enclosure very closely but that there is enough space between the sides of the shaped extruded enclosure and cap assembly and the plunger to both allow the plunger to move longitudinally/axially within the shaped enclosure and to allow the fluid softening/bonding/solvent agent to escape the cavity formed by the bottom of the plunger and the fitted enclosure when a longitudinal/axial force is applied but not allow the solids to escape. Alternatively, channels/holes can exist in the sides or body of the plunger to allow the softening/bonding/solvent agent whatever the case may be to be expelled from the solids. Furthermore, the plunger may or may not be hollow with a solid bottom and/or top with holes in the sides to allow the exuded liquid bonding/softening/solvent agent to enter the hollow cavity in the middle of the plunger thereby collecting the liquid and preventing the liquid from overflowing the enclosure or returning to the solids. The “cap” of the enclosure may be constructed of one or more pieces to create one “cap”. As an option, this expelled softening/bonding agent/liquid that escapes the enclosure can also be collected on a dish, a collection vessel attached to the cap and/or stabilizing base or other vessel/base. This liquid collection vessel/base may or may not be part of the cap and/or plunger or attached to the cap and/or plunger by pressure or other mechanical means. Other options include shapes in the cap and/or plunger that can imprint or emboss art or other shapes on the softened pieces of solids when pressure is applied. These shapes can form part of the cap and/or plunger but also may be separate pieces that are inserted between the cap and plunger and the solid/liquid mixture. Due to the design of the plunger, the pressure to be applied to the plunger may or may not be mechanical to prevent binding of the plunger within the enclosure. That is to say the hands, the feet, other body part or other mechanical means will be used to apply direct pressure to the plunger that then is forced longitudinally within the enclosure compressing the solid/liquid mixture. Under pressure, the space and/or channels between the plunger and enclosure is such that it does not allow the solids to escape but the liquid can escape “up” between the sides of the shaped enclosure and the plunger. This forces the softening/bonding agent out from surrounding the solid pieces. This bonding agent may or may not be collected in a vessel/base or the hollow plunger which may or may not be attached to the mould. Additionally, the “mould” assembly may be secured to a stabilizing platform onto which the user can step thereby using their own weight to stabilize the “mould” assembly while another body part (i.e. foot or arms) applies a compression force to the plunger or some other mechanical means of depressing the plunger. The design of the device that enables the user with or without any mechanical device to use their own body weight to apply axial force to the plunger without concern for binding is important to mass adoption of the device opening its use to a wide range of users regardless of age or ability. The addition of the stabilizing base although not key to the use of the device further increases the safety of the use of the device. After the user determines enough pressure has been applied to the plunger to fuse the solid pieces and expel the softening/bonding agent/liquid, the “mould” may be turned over and allowed to “dry” for a period of time. This is an optional step since because the exudates can be collected within the cavity of the plunger with any extra exudates collected elsewhere (i.e. the stabilizing platform), the exudates is no longer able to return to the mould cavity where the newly formed solids are. This “mould” may or may not be placed on a liquid/bonding agent collection vessel/base that may or may not be attached permanently or temporarily to the mould. After a length of time determined by the user which is dependent on the type of liquid softener/bonding agent used, the length of immersion of the solids in the softening/bonding agent and the softness of the solids pieces when the plunger was depressed, the cap on the end of the mould can be removed and pressure applied to the plunger to force the moulded solids out the other end of the enclosure. The solids will have taken the shape (in whole or in part) of the cavity formed by the enclosure and the cap and depressed plunger, including any custom imprints or embossing applied there. To aid removal of the newly formed solid shape, the cap can be removed and the plunger used to push the solid shape out of the enclosure. This is then allowed to dry further until the user determines the product is solid enough to be removed from the mould. To aid the removal of the fused product from the mould a release agent (i.e. Vaseline or other lubricant/wax) may be applied to any or all contact surfaces between the soap and mould). Alternatively a non-stick surface permanently applied to any or all of the surfaces of the mould. As a third alternative, any or the entire mould may be constructed of a non-stick material (i.e. plastics or metals). As a fourth alternative a thin barrier may be applied to any or all the surfaces of the mould (i.e. Teflon sheet, wax paper, etc . . . ).

Plunger

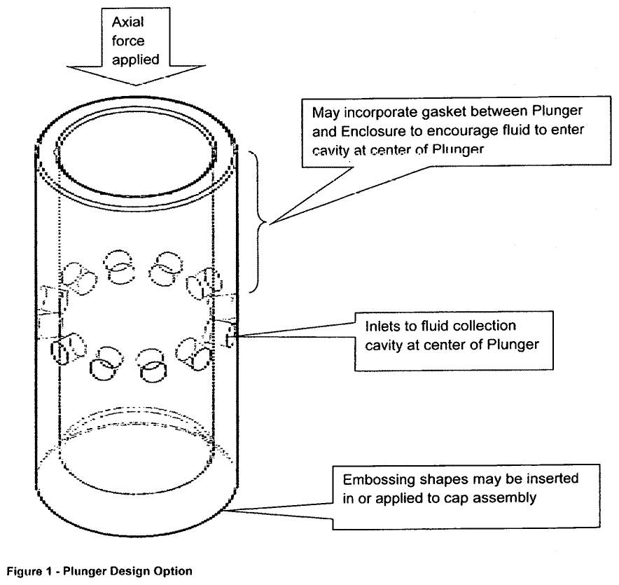

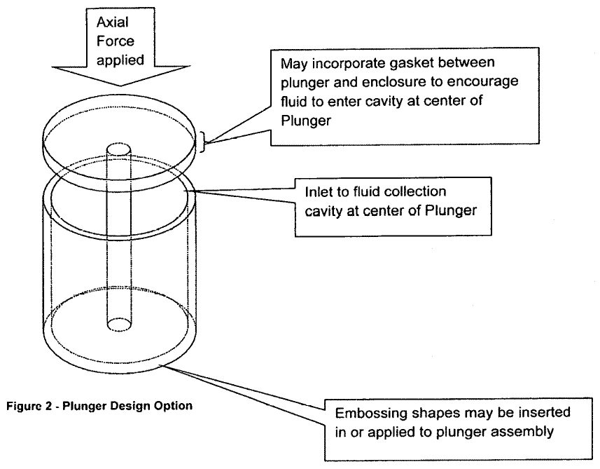

The plunger is the most unique and innovative aspect of this design. It can be any cross section except the outside cross section must match the inside cross-section of the enclosure closely while allowing longitudinal movement within the enclosure and fluid movement between the outside surface of the plunger and the inside surface of the enclosure. The plunger may also have holes or channels in the sides to allow the softening/bonding/solvent fluid to escape the cavity formed by the cap, enclosure and plunger when under pressure yet not allow the solids to escape. The plunger must be able to move freely longitudinally within the enclosure. Furthermore, the plunger can be hollow with holes leading from the outside longitudinal surface of the plunger to the inner cavity (see FIG. 1—Plunger Design Option). When the liquid softening/bonding agent is exuded from the solid/liquid mixture in the mould, it is forced up the sides between the solid sides of the plunger and the solid enclosure. This will occur until it reaches the level of the holes or inlet where the liquid is able to enter the cavity in the middle of the plunger and be collected inside the plunger cavity. This prevents the liquid agent from overflowing the mould creating a mess and making it difficult to recycle the liquid softening/bonding agent. Furthermore, a circumferential channel or groove may be inscribed at the level of the inlet holes to enable/encourage the liquid to travel circumferentially until it reaches the inlet holes to the cavity in the middle of the plunger. Further a sealing gasket between the plunger and enclosure between the level of the inlet to the centre of the plunger and the end of the plunger where the axial force is being applied. This may be used to encourage the fluid to collect in the cavity in the middle of the plunger. The enclosure should have level indicators guiding the user the recommended level above which there should be no liquid which will prevent the softening/bonding agent from reaching the top of the enclosure prior to reaching the level of the intake that allows the liquid/bonding agent to flow into the cavity in the middle of the plunger. Other shapes of the plunger can be used to create a collection cavity in the plunger to collect the exudates (i.e. a cup shaped plunger base with central post leading up to a cap for applying axial force to the plunger) (see FIG. 2—Plunger Design Option). The salient feature is that the exudates are able to travel to and be collected in a cavity inside the plunger. As a precaution against misuse of the device, any exudates that escapes the mould could he collected in a vessel formed in the cap or the stabilizing platform. Another unique feature of the plunger is that the length of the plunger cross-section that closely matches the interior cross-section of the enclosure is long enough that by virtue of the extended length of the plunger, this maintains the alignment of the plunger body within the enclosure when an axial force is applied preventing the plunger from binding within the enclosure “shaft”. This length of this section of the plunger would be such that the height of the alignment section be at least as great as the longest distance diagonally from the inside of one edge of the enclosure to the opposite edge. In this way, there is no need for mechanical devices to ensure alignment of the plunger in the enclosure to prevent binding while an axial force is applied to the top of the plunger. Finally, although not crucial to operation of the cold compression mould, the overall length of the plunger shall be at least as long as the outside longitudinal length of the enclosure so that when the cap is removed by the user, the newly formed solid can be expelled from the enclosure axial force applied to the plunger.

Enclosure

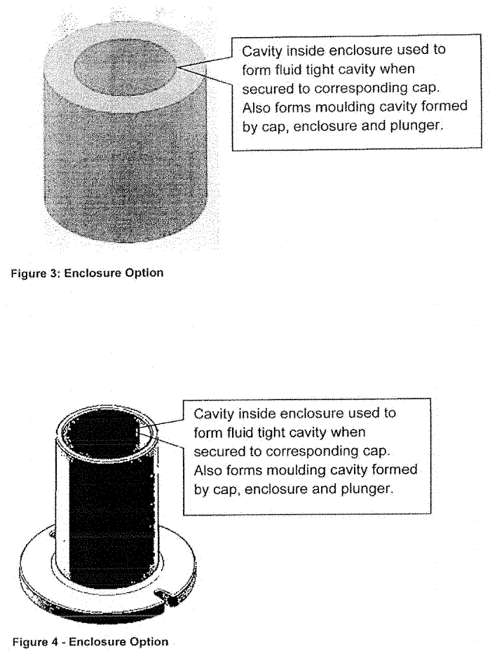

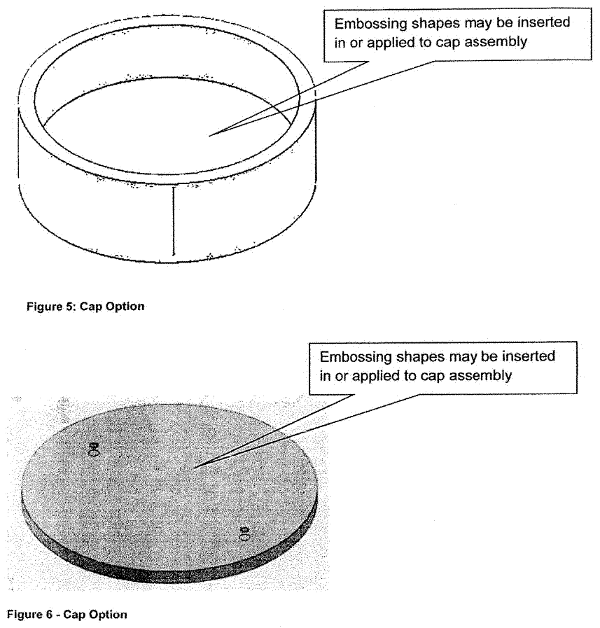

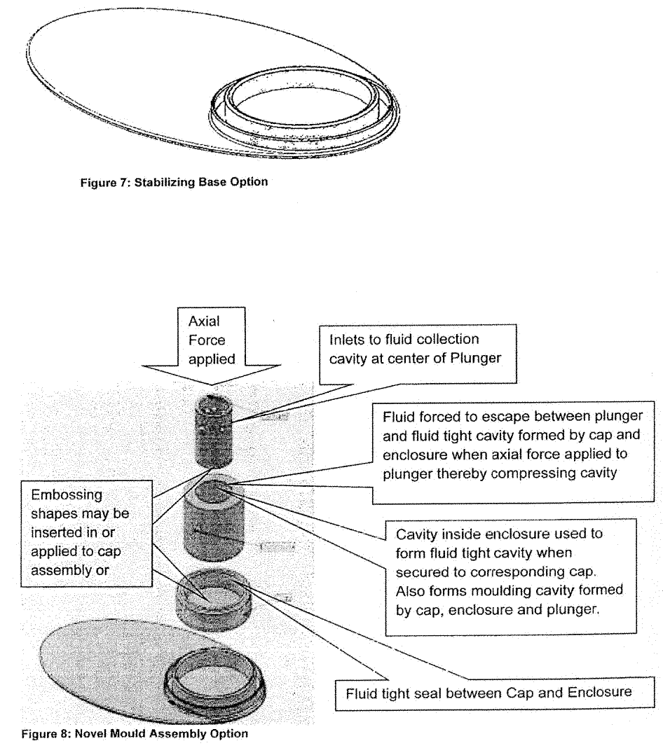

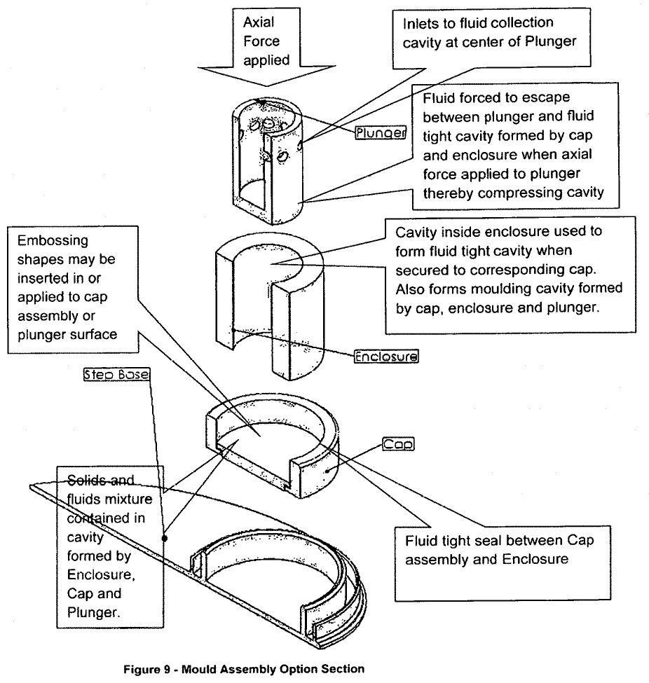

Inside and outside of the enclosure may be any shape/cross-section but the inside cross-section must allow the plunger to move freely longitudinally inside and be of similar shape to the exterior cross section of the plunger while allowing the softening /bonding agent a route to escape between the walls of the plunger and the enclosure when an axial force is applied to the plunger but not allowing the solids to escape the cavity formed by the cap (see FIG. 5: Cap Option or FIG. 6—Cap Option), the inside of the enclosure and the bottom of the plunger (see FIG. 3: Fnclosure or FIG. 4—Enclosure Option). The enclosure may have mechanical or pressure means of securing the cap in place either at one or both ends. The cross-section of the outside of the enclosure can be different from the cross section of the inside of the enclosure. However, the cross-section of the outside of the enclosure must allow the cap to form a liquid tight seal on the bottom and/or top. Further, the cross-section of the inside of the enclosure must allow the plunger to move longitudinally within the enclosure (i.e. typical cross-sections would be but are not limited to round or a polygon. Other shapes are possible but are not limited to dogs, flowers, etc . . . ).

Cap

The cap is designed to create a fluid tight seal on one end or both ends of the enclosure (see FIG. 5: Cap Option or FIG. 6—Cap Option). It may be constructed as one piece or as multiple pieces. May also include a gasket to seal the end. In any case, it will provide a fluid tight seal through either a pressure fit or other mechanical means. Exterior of the cap may be any shape and may incorporate a method of collecting the exuded fluid which could be a permanent part of the cap or an attachment. As a typical example, the cap may be a single moulded piece that secures to one or either end of the enclosure or two pieces with the edges of the cap providing the securement of the cap to the enclosure through pressure/friction or other mechanical means and the end allowing interchangeable end pieces which may or may not be imprinted or embossed with art or other shapes to be imprinted or embossed on the softened soap or other solids (see FIG. 5: Cap Option) A second example of Cap design could be a flat surface with mechanical attachment to the enclosure forming a fluid tight seal with the enclosure which may or may not ruse a gasket (see FIG. 6—Cap Option). Finally, the outside cross-section and shape of the cap may be such that it can be secured to and not preclude the use of an optional stabilizing base. Alternatively it may incorporate a larger stabilizing base.

Stabilizing Base

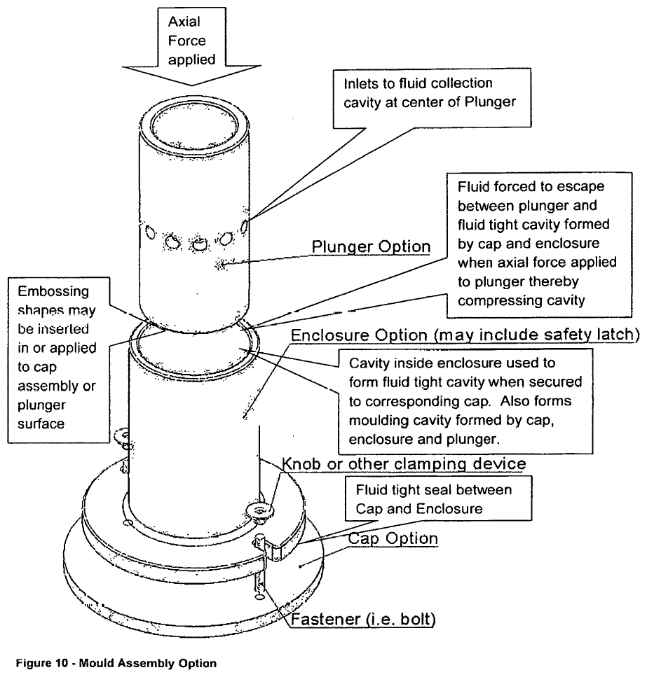

A base may be permanently or temporarily attached to the cap using either pressure or other mechanical means (see FIG. 7: Stabilizing Base). This base may provide extra stability to the mould during compression of the solids and softening agent meant to exude the softening/bonding agent from the solids. It may also include a method of collecting the exuded softening fluid. Furthermore, the stabilizing base can secure the mould while being rigid enough and of such a size so the stabilizing base itself may be secured from moving with the use of the user's or other persons weight or some other mechanical means. Typical materials would be metals or rigid plastics. The ability to use your own body weight to stabilize the mould and use your own body weight to apply an axial force to the plunger (i.e. hands or feet) increases the usability of the device and opens the process up to a wider audience making it usable regardless of age or ability increasing the likelihood of mass adoption of the process and device.

1. The design of the plunger enables and encourages the exudates to be collected in a cavity in the middle of the plunger (see FIG. 1—Plunger Design Option or FIG. 2—Plunger Design Option).

2. The design of the plunger body (where the length of the plunger body is at least as long as the largest diameter) is such that it prevents binding of the plunger when moved longitudinally within the enclosure.

3. The device and process enables forming of a plurality of disparate solids into a single solid without the need for electricity or heat or the transfer of “treated” solids from a separate vessel into the mould, the entire process is performed in one device without the need for electricity or heat.

4. The optional stabilizing base which may or may not incorporate an exudates collection method both increases the safety of the device while the axial force is applied to the plunger but also increases the usability of the mould by making it easier to use regardless of age or ability. The anchoring force of the stabilizing base can be but is not limited to the users own weight (see FIG. 7: Stabilizing Base Option).

5. The cap may incorporate a method of stabilizing the mould and/or collect any excess exudates.

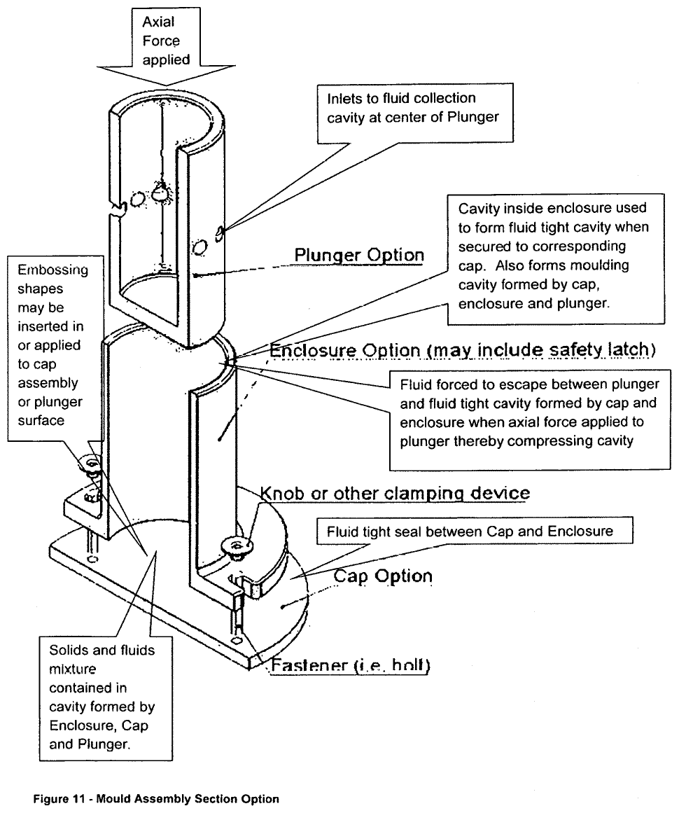

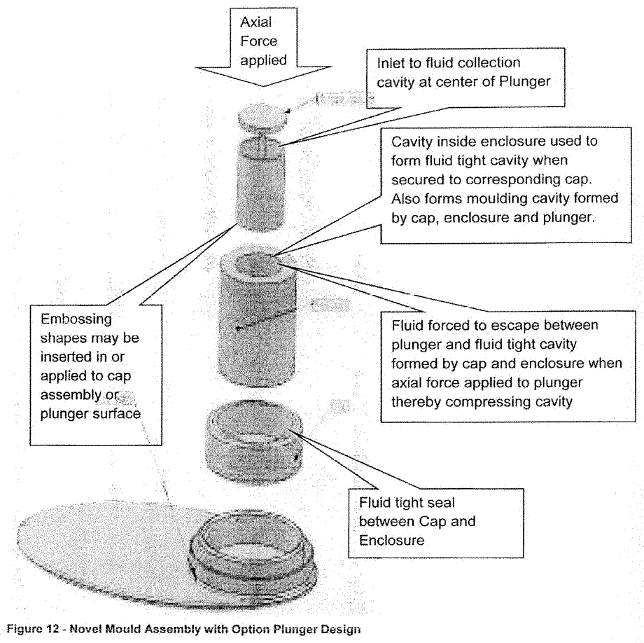

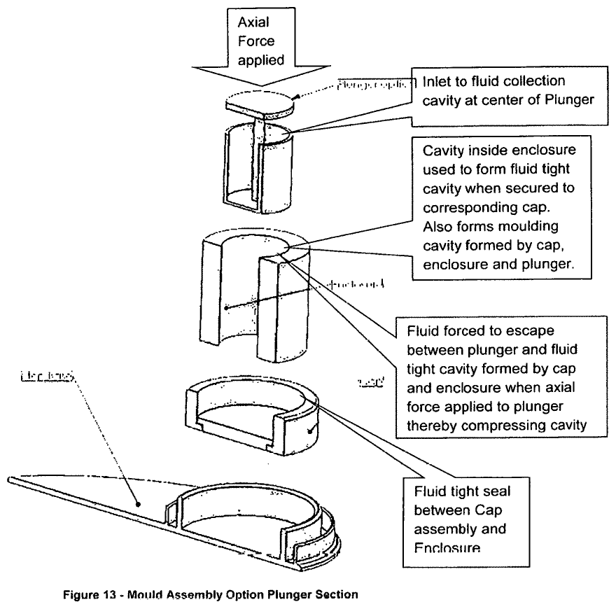

6. This process and apparatus can be used to bond a plurality of disparate solids into a single solid shape as long as the smaller solids are immersed in a fluid that makes the surfaces bondable to each other. Possible combinations include but are not limited to soap pieces in water (which may or may not include other solids, liquids, oils, scents), plastics in the corresponding solvent, etc . . . (see FIG. 10—Mould Assembly Option, FIG. 8: Novel Mould Assembly , or FIG. 12—Novel Mould Assembly with Option Plunger Design)
